(19) United States
(12) Patent Application Publication
(10) Pub. No.: US 2026/0339742 A1
(43) Pub. Date: Oct. 29, 2026

(54) AI DEFINED SOFT PHONE

(71) Applicant: AT&T Intellectual Property I, L.P., Atlanta, GA (US)

(72) Inventors: Yupeng Jia, South Pasadena, CA (US); Hongyan Lei, Plano, TX (US)

(73) Assignee: AT&T Intellectual Property I, L.P., Atlanta, GA (US)

(21) Appl. No.: 19/192,696

(22) Filed: Apr. 29, 2025

(51) Int. Cl. G06F 9/50; G06T 1/20

(52) U.S. Cl. CPC G06F 9/5061; G06T 1/20; G06F 2209/501

(57) ABSTRACT

Aspects of the subject disclosure may include, for example, a device utilizing a distilled artificial intelligence (AI) model to dynamically allocate resources in user equipment (UE). The AI model, received from a server, analyzes application requests to determine resource allocations. The device adjusts resource allocation based on real-time metrics, battery status, and network loading, enhancing multitasking and execution of complex applications like AI and extended reality (XR). Other embodiments are disclosed.

### FIELD OF THE DISCLOSURE

The subject disclosure relates to wireless communications technologies.

### BACKGROUND

In the rapidly evolving landscape of mobile technology, smartphones and similar devices face significant challenges in efficiently managing computational resources. As users increasingly demand more from their devices, including multitasking capabilities and the execution of complex applications such as artificial intelligence (AI) and extended reality (XR), traditional resource management approaches often fall short. These conventional methods can lead to inefficient resource allocation, resulting in lag, suboptimal performance, and reduced battery life.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning in coordination with the communication network of FIG. 1 in accordance with various aspects described herein.

FIG. 2B is a block diagram illustrating an example, non-limiting embodiment of laysers within a system functioning in coordination with the communication network of FIG. 1 in accordance with various aspects described herein.

FIGS. 2C and 2D depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for utilizing a distilled artificial intelligence (AI) model to dynamically allocate computational resources in user equipment (UE). Other embodiments are described in the subject disclosure.

One or more aspects of the subject disclosure include a device, comprising a processing system including a processor and a memory that stores executable instructions that, when executed by the processing system, facilitate performance of operations. The operations may include receiving, by the device, a student artificial intelligence (AI) model from a server, wherein the student model is derived from a teacher AI model maintained by the server; executing the student AI model using a graphics processing unit (GPU) of the device; receiving, by the device, one or more inputs corresponding to application requests via a user interface; analyzing, by the device, the received inputs using the student AI model to determine a resource allocation strategy; allocating, by the device, computational resources between a central processing unit (CPU) and the GPU based on the resource allocation strategy; and executing, by the device, the application requests using the allocated computational resources.

Additional aspects of the subject disclosure may include a performance monitoring module configured to monitor execution metrics associated with the application requests and refine the resource allocation strategy based on these metrics; a battery status sensor operable to obtain battery level information, whereby the resource allocation strategy is adjusted based on the battery level information; and a network interface configured to receive real-time network loading information, wherein the resource allocation strategy is dynamically adjusted based on the real-time network loading information. The one or more inputs corresponding to application requests may include user interface interactions, voice commands, and touch inputs. The graphics processing unit (GPU) may be configured to concurrently execute the student AI model and perform parallel processing tasks for AI-driven functionalities. Allocating the computational resources between the central processing unit (CPU) and the GPU may comprise dynamically reassigning additional computational resources in response to real-time assessments of application performance demands. Executing the application requests may further comprise executing the application requests within an isolated virtual machine environment instantiated on the device. Additionally, the device may include an interface configured to transmit performance metrics related to the application requests to the server, wherein the performance metrics are used to update the teacher AI model for subsequent derivation of the student AI model.

One or more aspects of the subject disclosure include a non-transitory machine-readable medium, comprising executable instructions that, when executed by a processing system including a processor, facilitate performance of operations. The operations may include receiving from a server device, by a user equipment (UE), a first artificial intelligence (AI) model derived from a second AI model, wherein the second AI model is trained on data from a plurality of UEs; executing the first AI model using a graphics processing unit (GPU) within the UE; receiving, by the UE, one or more inputs corresponding to application requests via a user interface of the UE; analyzing, by the UE, the received inputs using the first AI model to determine a resource allocation strategy; allocating, by the UE, computational resources between the processor and the GPU of the UE based on the resource allocation strategy to produce allocated computational resources; and executing the application requests using the allocated computational resources.

Additional aspects of the subject disclosure may include monitoring, by the user equipment (UE), a plurality of performance metrics corresponding to the application requests to determine monitored performance metrics, and adjusting the resource allocation strategy based on these monitored performance metrics. The operations may further comprise transmitting, by the UE, the monitored performance metrics to the server device to facilitate updating the second AI model for subsequent derivation of the first AI model. Additionally, the operations may include receiving, by the UE, real-time network loading information and battery status information, and dynamically adjusting the resource allocation strategy based on the received real-time network loading information and battery status information.

One or more aspects of the subject disclosure include a method, comprising: receiving from a server device, by a user equipment (UE) including a processor, a first artificial intelligence (AI) model derived from a second AI model, wherein the second AI model is trained on data from a plurality of UEs; storing, by the UE, the first AI model to create a local AI model; receiving, by the UE, one or more inputs corresponding to application requests via a user interface of the UE; analyzing, by the UE, the one or more inputs using the local AI model to determine a resource allocation strategy; allocating, by the UE, computational resources between the processor and a graphics processing unit (GPU) of the UE based on the resource allocation strategy to produce allocated computational resources; and executing the application requests using the allocated computational resources.

Additional aspects of the subject disclosure may include monitoring, by the user equipment (UE), a plurality of performance metrics corresponding to the application requests to determine monitored performance metrics, and transmitting these metrics to the server device to facilitate updating the second AI model. The method may further comprise storing the first AI model by distilling the second AI model to create a compressed local AI model tailored to the UE's hardware configuration. Additionally, the method may include receiving real-time network loading information and battery status information, and adjusting the resource allocation strategy based on this information. Analyzing the one or more inputs may involve prioritizing the application requests based on a predetermined application profile stored in the UE. Allocating the computational resources may comprise dynamically reassigning additional resources between the processor and the GPU in response to real-time assessments of application performance demands. Furthermore, the method may include executing the application requests within a virtual machine environment instantiated by the UE, thereby isolating the application requests from other applications.

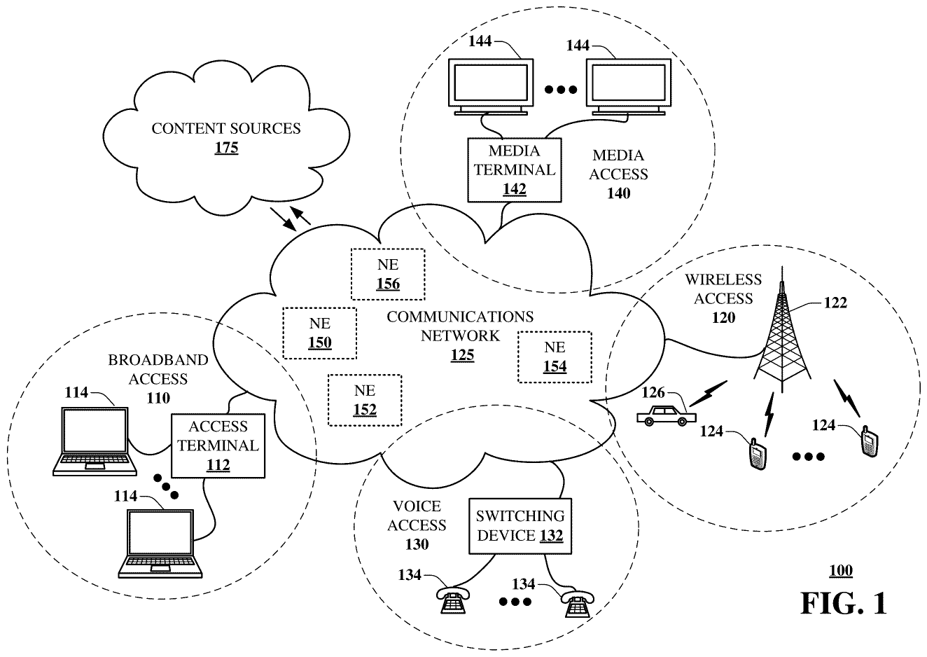

Referring now to FIG. 1, a block diagram is shown illustrating an example, non-limiting embodiment of a system 100 in accordance with various aspects described herein. For example, system 100 can facilitate in whole or in part utilizing a distilled artificial intelligence (AI) model to dynamically allocate computational resources in user equipment (UE). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In the context of FIG. 1, various embodiments introduce concepts of dynamic resource allocation and edge computing to enhance the performance and efficiency of mobile devices 124, which in some embodiments function as user equipment (UEs). In some embodiments, these mobile devices interact with various components within the communications network 125, which may include a server that houses a teacher AI model. For example, this server may maintain and refine a teacher AI model, which is trained on data from a multitude of UEs, and distill this comprehensive model into student models tailored to the specific hardware configurations and resource capabilities of each UE. In some embodiments, the teacher AI model may be maintained on the server, and in other embodiments, the teacher AI model may be maintained separately (e.g., in the cloud), and is accessible by the server.

In some embodiments, the mobile devices 124 leverage the student AI models to dynamically allocate computational resources between their various resources (e.g., CPUs and GPUs). For example, this allocation may be based on real-time assessments of application demands, allowing the devices to optimize performance for a wide range of applications, from gaming and extended reality (XR) to real-time data analytics. A mobile device running a graphics-intensive application might allocate more GPU resources to ensure high-quality rendering, while another device processing real-time analytics might prioritize CPU resources for efficient data handling.

In some embodiments, edge computing is integrated into the system to further enhance the capabilities of mobile devices 124. In some embodiments, by connecting UEs to edge nodes within the communications network 125, the system reduces latency and improves computational efficiency. For example, edge computing allows mobile devices to offload intensive processing tasks to nearby edge nodes, thereby reducing the load on local resources and enhancing real-time application performance. This integration supports scalable service provisioning and dynamic resource adjustment based on real-time demand, ensuring that mobile devices can handle fluctuating workloads efficiently.

The interactions between mobile devices 124 and the server within the communications network 125 facilitate a feedback loop that continuously improves the AI models. In some embodiments, performance metrics collected from the UEs are sent back to the server, enabling it to refine the teacher model and update the student models accordingly. For example, this iterative process may ensure that the AI models remain responsive to evolving user needs and technological advancements, supporting seamless operation and innovative functionalities across a diverse range of applications. By incorporating these concepts, various embodiments provide a framework for managing computational resources and enhancing user experience in mobile devices.

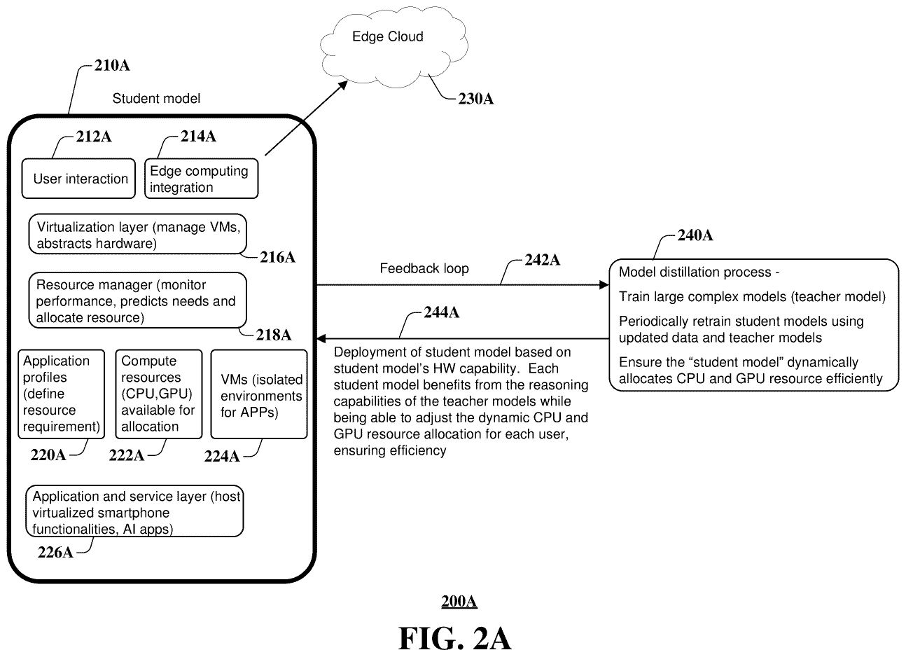

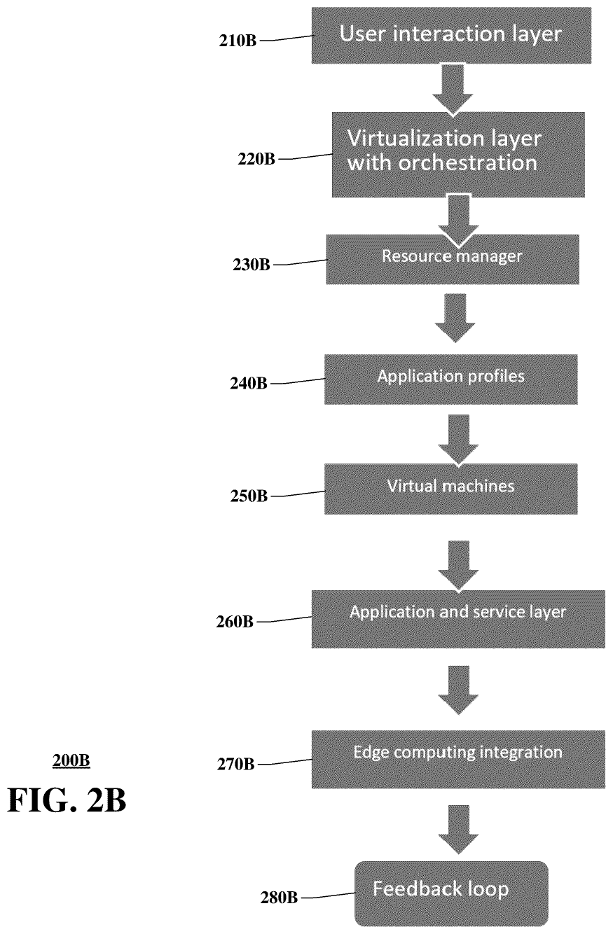

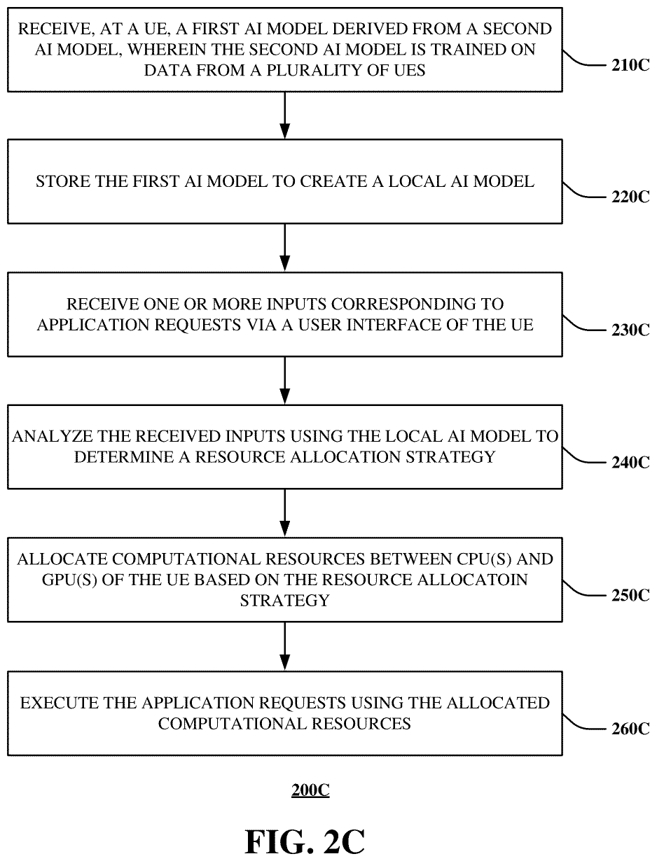

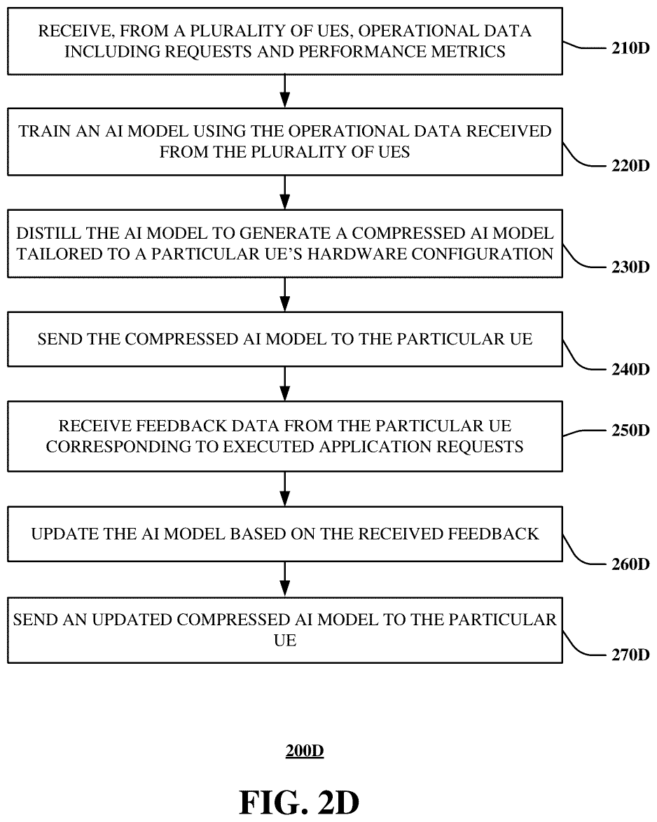

FIG. 2A is a block diagram illustrating an example, non-limiting embodiment of a system functioning in coordination with the communication network of FIG. 1 in accordance with various aspects described herein.

System 200A includes UE with Student Model 210A, User Interaction component 212A, Edge Computing Integration component 214A, Virtualization Layer 216A, Resource Manager 218A, Application Profiles 220A, Compute Resources 222A, virtual machines (VMs) 224A, Application and Service Layer 226A, Edge Cloud 230A, Model Distillation Process 240A, Feedback Loop 242A, and Deployment of Student Model 244A.

The UE with Student Model (210A) encompasses functional components that facilitate dynamic resource allocation. In some embodiments, the UE may include components such as a processor and memory to execute the student AI model. For example, the UE might implement the student model to analyze application requests and optimize resource distribution. Further, in some embodiments, the UE may be implemented with a GPU to execute AI-driven functionalities.

User Interaction component 212A captures inputs from users, such as touch or voice commands. In some embodiments, this component may be implemented using various interfaces to receive user inputs. For example, a touchscreen interface can be employed to detect touch gestures and initiate application requests. Additionally, a microphone may be used to receive voice commands, allowing users to interact with the device hands-free. Furthermore, the component can be integrated with devices coupled via Bluetooth, enabling input from external peripherals such as keyboards, mice, or game controllers.

The application requests can vary widely depending on the type of application. For example, an extended reality (XR) application may request reduced latency to provide a seamless and immersive user experience, benefiting from rapid data processing and minimal delay. On the other hand, a gaming application might request increased GPU resources to render high-quality graphics and ensure smooth gameplay. Similarly, a video editing application could benefit from enhanced GPU allocation to accelerate rendering and processing tasks. In some cases, a navigation application might prioritize real-time data updates and location tracking, requiring efficient CPU resource allocation. These examples illustrate how different applications can leverage the user interaction component to request specific resource allocations tailored to their unique performance needs.

Edge Computing Integration component 214A connects the UE to edge nodes, reducing latency and enhancing computational efficiency. In some embodiments, this component may be implemented using network interfaces that facilitate communication between the UE and nearby edge computing resources. For example, the UE might leverage edge computing to offload intensive processing tasks, thereby enhancing real-time application performance and reducing the load on the device's local resources.

In various embodiments, edge computing plays a role in resource allocation and improving user experience. By bringing computational resources closer to the user, edge computing reduces the time it takes to process and respond to application requests, which is particularly beneficial for applications requiring low latency, such as extended reality (XR) and real-time gaming. This integration allows the UE to dynamically adjust resource allocation based on real-time assessments of application performance demands, ensuring that the most demanding tasks are handled efficiently.

Various embodiments described herein highlight the use of edge computing to support scalable service provisioning and to dynamically adjust resources based on real-time demand. This capability is useful for managing diverse workloads, such as AI processing, gaming, and browsing, which can create bottlenecks and inefficiencies if not properly managed. By integrating edge nodes, the system can provide tailored resource allocation and improved performance for each application, thereby supporting business growth and fluctuating workloads efficiently.

Additionally, edge computing may enhance the performance of AI-driven functionalities. For example, by offloading AI processing tasks to edge nodes, the UE can optimize the use of its local CPU and GPU resources, extending battery life and improving overall energy efficiency. This approach also enables the UE to execute advanced applications like AI and XR more effectively, ensuring smooth operation and enabling innovative functionalities such as real-time language translation and immersive AR/VR experiences.

Edge Cloud 230A interfaces with the UE to provide expanded capabilities, enhancing the device's ability to handle complex applications and workloads. In some embodiments, this component may be implemented using cloud computing services that offer scalable and flexible computational resources. For example, the UE might access additional computational resources from the edge cloud to support demanding applications such as AI processing, extended reality (XR), or real-time data analytics.

The integration of Edge Cloud with the UE allows for the offloading of intensive processing tasks, reducing the burden on local resources and improving overall device performance. In some embodiments, the edge cloud can provide supplementary GPU or CPU resources, enabling the UE to execute applications that require high computational power without compromising on speed or efficiency. For instance, an AI-driven application might utilize edge cloud resources to perform complex model training or inference tasks, while an XR application could leverage the cloud's capabilities to render high-quality graphics and deliver immersive experiences.

The Edge Cloud component works in conjunction with the Edge Computing Integration component 214A to optimize resource allocation and enhance user experience. By bringing computational resources closer to the user, edge computing reduces latency and improves the responsiveness of applications. In some embodiments, the edge cloud can dynamically adjust resource allocation based on real-time assessments of application performance demands, ensuring that the most resource-intensive tasks are handled efficiently.

This synergy between Edge Cloud and Edge Computing Integration allows the UE to adapt to fluctuating workloads and user demands, providing a seamless and responsive experience. For example, during peak usage periods, the edge cloud can allocate additional resources to support increased demand, while edge computing ensures low-latency communication and processing. Together, these components enable the UE to deliver advanced functionalities and services, supporting business growth and enhancing user satisfaction.

Virtualization Layer 216A manages virtual machines (VMs) 224A and abstracts hardware resources, allowing for efficient resource allocation and isolation of applications. In some embodiments, this component may be implemented using software virtualization techniques, enabling the UE to create isolated environments for applications. For example, the UE might use hypervisors or containerization technologies to instantiate VMs, each tailored to specific application requirements.

In some embodiments, VMs 224A may be instantiated to allocate resources dynamically based on application demands. For instance, in some embodiments, a VM may be configured to prioritize GPU resources for a graphics-intensive application, such as a gaming or video editing software, ensuring optimal performance and responsiveness. In other embodiments, another VM may be set up to allocate more CPU resources for applications that require intensive data processing, such as real-time analytics or machine learning tasks.

The virtualization layer allows for flexible and adaptive resource management, where VMs 224A can be scaled up or down depending on the current workload and performance metrics. For example, during peak usage periods, additional VMs can be instantiated to handle increased demand, distributing computational tasks across multiple virtual environments to prevent bottlenecks and maintain smooth operation.

Furthermore, the virtualization layer can facilitate the isolation of applications, enhancing security and stability by preventing interference between different applications running on the UE. This isolation ensures that resource allocation for one application does not adversely affect the performance of others, providing a stable and secure environment for executing diverse workloads.

Resource Manager 218A monitors performance and predicts resource needs, playing a significant role in the dynamic allocation of computational resources within the UE. In some embodiments, this component includes the student AI model, which, in some embodiments, is a distilled version of a teacher model maintained on a server. The distillation process involves refining the teacher model into a smaller, more efficient student model that is tailored to the specific hardware and resource capabilities of the UE. This ensures that the AI model is optimized for execution on the device, taking into account its processing power, memory, and other constraints.

In some embodiments, the student AI model is executed using the graphical processing unit (GPU) resources on the UE, leveraging the parallel processing capabilities of the GPU to efficiently handle AI-driven tasks. For example, this execution allows the resource manager to analyze application requests and determine the most effective resource allocation strategy, ensuring that the UE can meet the performance demands of various applications.

In some embodiments, metrics related to application performance and resource utilization are continuously gathered by the resource manager. In some embodiments, these metrics may include CPU and GPU usage levels, application response times, battery consumption rates, and network latency. These metrics provide valuable insights into how well the current resource allocation strategy is meeting the needs of the applications running on the UE. The gathered metrics serve as training data that can be used to refine both the student and teacher models, ensuring they remain accurate and efficient, adapting to changes in application demands and device capabilities over time.

In some embodiments, the resource manager 218A dynamically reallocates resources between the CPU and GPU based on real-time assessments of application performance and system metrics. This dynamic reallocation helps optimize the use of available resources, enhancing the overall performance and efficiency of the UE. By continuously monitoring and adjusting resource allocation, the resource manager ensures that the UE can effectively handle a wide range of applications and workloads.

The terms “student AI model” and “teacher AI model” are used as labels to refer to the different models within the system. These terms are not meant to be limiting but rather serve as convenient identifiers to distinguish between the model that is executed on the UE and the model maintained on the server. The student model is derived from the teacher model, allowing for efficient resource allocation tailored to the specific capabilities of the UE.locate resources based on real-time assessments.

Application Profiles 220A define resource requirements for applications, serving as a guide for the resource manager in making allocation decisions. In some embodiments, this component may be implemented using predefined profiles that specify the computational needs and priorities of various applications. For example, the UE might prioritize resource allocation based on application demands, ensuring that each application receives the necessary resources to function optimally.

In some embodiments, application profiles may include parameters such as CPU and GPU usage requirements, memory allocation, latency sensitivity, and power consumption targets. These profiles can be created based on historical data, user preferences, and application-specific benchmarks. For instance, an extended reality (XR) application profile might emphasize low latency and high GPU usage to deliver a seamless immersive experience, while a video editing application profile might prioritize GPU resources for rendering tasks.

Application profiles can be updated dynamically based on real-time performance metrics and user feedback. In some embodiments, the UE may continuously monitor application performance and adjust profiles to better align with current demands. This adaptive approach ensures that resource allocation remains efficient and responsive to changing conditions.

The application profiles work in conjunction with application requests to determine resource allocation strategies. When an application request is received, the resource manager analyzes the corresponding application profile to understand the specific resource needs and priorities. This analysis, combined with real-time assessments of system metrics, allows the UE to allocate resources effectively, ensuring optimal performance for each application. By leveraging application profiles, the system can tailor resource distribution to meet the unique requirements of diverse applications, enhancing overall device efficiency and user experience.

Compute Resources (222A) represent the available CPU and GPU resources within the UE, which can be dynamically allocated to meet the varying demands of different applications and virtual machines (VMs). In some embodiments, this component may be implemented using hardware specifications that define the processing capabilities and limitations of the device. For example, the UE might allocate computational power between the CPU and GPU based on the specific requirements of each application or VM.

In some embodiments, the allocation of compute resources can be tailored to optimize the performance of individual applications. For instance, a graphics-intensive application, such as a gaming or video editing software, may be allocated more GPU resources to ensure high-quality rendering and smooth operation. Conversely, an application that requires intensive data processing, such as real-time analytics or machine learning tasks, might be allocated additional CPU resources to handle complex computations efficiently.

The student AI model, which is executed on the UE, can make use of the GPU resources to perform AI-driven tasks. In some embodiments, the student AI model leverages the parallel processing capabilities of the GPU to analyze application requests and determine the most effective resource allocation strategy. This allows the UE to dynamically adjust the distribution of compute resources between the CPU and GPU, ensuring that each application or VM receives the necessary resources to function optimally.

By utilizing the student AI model, the UE can continuously assess the performance demands of running applications and reallocate compute resources in real-time. This dynamic allocation helps optimize the use of available resources, enhancing the overall performance and efficiency of the device. By effectively managing compute resources, the UE can support a wide range of applications and workloads, providing a seamless and responsive user experience.

Application and Service Layer 226A hosts virtualized functionalities and AI-enhanced applications, providing a platform for executing diverse software solutions on the UE. In some embodiments, this component may be implemented using software frameworks that support the deployment and management of applications in a virtualized environment. For example, the UE might utilize containerization technologies or hypervisors to run applications in isolated environments, ensuring security and stability.

In some embodiments, the Application and Service Layer can support a variety of applications, ranging from productivity tools and multimedia applications to advanced AI-driven solutions. For instance, an AI-enhanced application for real-time language translation might leverage the capabilities of this layer to process and translate spoken words on-the-fly, providing users with seamless communication across different languages. Similarly, an augmented reality (AR) application could use this layer to overlay digital information onto the physical world, enhancing user interaction and experience.

The Application and Service Layer may also facilitate continuous monitoring and adjustment of application performance. In some embodiments, the UE can track key performance indicators (KPIs) such as response time, resource utilization, and user engagement metrics. For example, if an application experiences a sudden increase in demand, the layer can dynamically allocate additional resources to maintain optimal performance. Conversely, if an application is underutilized, resources can be reallocated to other applications or services that require more computational power.

By hosting virtualized functionalities and AI-enhanced applications, the Application and Service Layer enables the UE to deliver a wide range of services and capabilities, enhancing the overall user experience. This flexibility allows the UE to adapt to changing user needs and application demands, ensuring that resources are used efficiently and effectively.

Model Distillation Process 240A represents a server that houses and updates the teacher model, serving as a central hub for refining and distributing AI models to user equipment (UE). In some embodiments, this component may be implemented using advanced machine learning techniques that facilitate the transformation of complex AI models into more efficient versions suitable for deployment on individual devices. For example, the server might distill the teacher model to generate student models tailored to the specific hardware configurations and resource capabilities of each UE.

The server maintains the teacher model, which is trained on extensive datasets collected from a multitude of devices, ensuring that it encompasses a broad range of scenarios and applications. This comprehensive model serves as the foundation for creating student models that are optimized for execution on UEs with varying computational resources. The distillation process involves extracting the essential knowledge and functionalities from the teacher model and compressing them into a student model that retains high performance while being lightweight enough to operate efficiently on the UE.

In some embodiments, the server continuously updates the teacher model based on feedback received from UEs, which includes performance metrics and application usage data. This iterative process allows the teacher model to evolve and adapt to changing user needs and technological advancements, ensuring that the derived student models remain relevant and effective. The server's ability to distill and distribute tailored student models enables UEs to leverage cutting-edge AI capabilities without the need for extensive local processing power, thereby enhancing device performance and user experience.

Feedback Loop 242A collects performance metrics to improve AI algorithms, serving as a vital mechanism for continuous enhancement and adaptation of the AI models within the system. In some embodiments, this component may be implemented using data analytics tools that aggregate and analyze data from user equipment (UE) to provide insights into application performance and resource utilization. For example, the server might use feedback from UEs to refine the teacher model, ensuring that it remains responsive to evolving user needs and environmental conditions.

The feedback loop operates by gathering a variety of performance metrics from UEs, such as CPU and GPU usage levels, application response times, battery consumption rates, and network latency. These metrics offer a comprehensive view of how effectively the current resource allocation strategies are meeting the demands of applications running on the UE. By analyzing this data, the server can identify patterns and trends that inform adjustments to the teacher model, enhancing its accuracy and efficiency.

In some embodiments, the feedback loop facilitates an iterative process where the server continuously updates the teacher model based on the collected metrics. This process allows the AI algorithms to adapt to changes in application demands, device capabilities, and user preferences, ensuring that the student models derived from the teacher model are optimized for execution on individual UEs. The feedback loop thus plays a crucial role in maintaining the relevance and effectiveness of the AI models, enabling dynamic resource allocation and improved application performance.

Deployment of Student Model 244A involves transmitting the student model to user equipment (UEs), ensuring that each device receives an AI model tailored to its specific hardware and resource capabilities. In some embodiments, this component may be implemented using network protocols that facilitate efficient and secure transmission of the student models from the server to the UEs. For example, the server might update student models based on the latest teacher model data, ensuring that the models reflect the most current insights and optimizations derived from the teacher model.

The deployment process begins with the server distilling the teacher model into a student model that is optimized for execution on individual UEs. This involves compressing the model to fit the computational constraints of the device while retaining the essential functionalities and performance characteristics. Once the student model is prepared, it is transmitted to the UE using network protocols that ensure data integrity and security during the transfer.

In some embodiments, the deployment of student models is a dynamic process, with updates being pushed to UEs as new data and insights become available. This ensures that the AI models on the devices remain up-to-date and capable of handling evolving application demands and user needs. The server may employ various strategies to manage the deployment process, such as scheduling updates during low-usage periods to minimize disruption or using differential updates to reduce the amount of data transmitted.

In some embodiments, the components interact to facilitate dynamic resource allocation in UEs. For example, the UE might receive user inputs, analyze them using the student model, and allocate resources accordingly. The server might update the teacher model based on feedback from UEs, ensuring continuous improvement and adaptation.

FIG. 2B is a block diagram illustrating an example, non-limiting embodiment of laysers within a system functioning in coordination with the communication network of FIG. 1 in accordance with various aspects described herein. System 200B illustrates a layered architecture within a system, including several components: User Interaction Layer 210B, Virtualization Layer with Orchestration 220B, Resource Manager 230B, Application Profiles 240B, Virtual Machines 250B, Application and Service Layer 260B, Edge Computing Integration 270B, and Feedback Loop 280B.

The User Interaction Layer 210B captures inputs from users, such as touch, voice commands, and other interactions. In some embodiments, this layer may be implemented using various interfaces, including touchscreens, microphones, and Bluetooth-connected devices. For example, a touchscreen interface can detect gestures to initiate application requests, while a microphone can capture voice commands for hands-free operation. This layer communicates with the Resource Manager to relay user inputs that influence resource allocation decisions.

The Virtualization Layer with Orchestration 220B manages virtual machines (VMs) and abstracts hardware resources, allowing for efficient resource allocation and isolation of applications. In some embodiments, this layer may be implemented using hypervisors or containerization technologies, enabling the creation of isolated environments for applications. For example, VMs can be instantiated to allocate resources dynamically based on application demands, such as prioritizing GPU resources for graphics-intensive applications. This layer interacts with the Resource Manager to ensure that resources are allocated according to the needs defined in the Application Profiles.

The Resource Manager 230B monitors performance and predicts resource needs, playing a significant role in the dynamic allocation of computational resources. In some embodiments, this component includes the student AI model, which is a distilled version of a teacher model maintained on a server. The Resource Manager uses the student AI model to analyze application requests and determine the most effective resource allocation strategy. It gathers metrics such as CPU and GPU usage, application response times, and battery consumption, which are sent back to the server via the Feedback Loop for model refinement. The Resource Manager communicates with the Virtualization Layer and Application Profiles to optimize resource distribution.

Application Profiles 240B define resource requirements for applications, guiding the Resource Manager in making allocation decisions. In some embodiments, these profiles may include parameters such as CPU and GPU usage requirements, memory allocation, and latency sensitivity. Profiles can be created based on historical data and user preferences and are updated dynamically based on real-time performance metrics. The Application Profiles work in conjunction with application requests to tailor resource distribution, ensuring optimal performance for each application.

Virtual Machines 250B provide isolated environments for applications, ensuring security and stability. In some embodiments, VMs may be implemented using containerization technologies, allowing applications to run independently of one another. This isolation prevents interference between applications and enables flexible resource management. VMs can be scaled up or down based on workload demands, distributing computational tasks across multiple environments to maintain smooth operation. The Virtual Machines interact with the Virtualization Layer and Resource Manager to receive allocated resources.

The Application and Service Layer 260B hosts virtualized functionalities and AI-enhanced applications, providing a platform for executing diverse software solutions. In some embodiments, this layer may be implemented using software frameworks that support application deployment and management. It supports a variety of applications, from productivity tools to advanced AI-driven solutions, and continuously monitors application performance to adjust resources as needed. This layer communicates with the Resource Manager to ensure that applications receive the necessary resources for optimal operation.

Edge Computing Integration 270B connects the UE to edge nodes, reducing latency and enhancing computational efficiency. In some embodiments, this component may be implemented using network interfaces that facilitate communication with nearby edge computing resources. By offloading intensive processing tasks to edge nodes, the UE can optimize local resource use and improve real-time application performance. This integration works with the Edge Cloud to dynamically adjust resource allocation based on real-time assessments of application demands.

The Feedback Loop 280B collects performance metrics to improve AI algorithms, serving as a mechanism for continuous enhancement of the AI models. In some embodiments, this component may be implemented using data analytics tools that aggregate data from UEs. The server uses feedback from UEs to refine the teacher model, ensuring it remains responsive to user needs. The Feedback Loop facilitates an iterative process where the server updates the teacher model based on collected metrics, enabling dynamic resource allocation and improved application performance. This loop communicates with the Resource Manager to provide insights for model refinement.

FIGS. 2C and 2D depict illustrative embodiments of methods in accordance with various aspects described herein. FIG. 2C is a flowchart illustrating methods that may be performed by a user equipment (UE), and may involve components describe with reference to previous figures such as the processing system, student AI model, and resource manager.

At block 210C, the UE receives a first AI model derived from a second AI model, wherein the second AI model is trained on data from a plurality of UEs. In some embodiments, this action involves the UE downloading a student AI model from a server, which has been distilled from a comprehensive teacher model. The server uses advanced machine learning techniques to tailor the student model to the specific hardware capabilities and resource constraints of the UE, ensuring efficient execution. This process allows the UE to leverage cutting-edge AI capabilities without extensive local processing power.

At block 220C, the UE stores the first AI model to create a local AI model. In some embodiments, this involves saving the student AI model in the UE's memory for subsequent use. The model is stored in a manner that allows for quick access during application execution, enabling the UE to efficiently analyze and respond to application requests. This local storage ensures that the UE can operate independently, even when network connectivity is limited.

At block 230C, the UE receives one or more inputs corresponding to application requests via a user interface. In some embodiments, this includes capturing user interactions such as touch gestures, voice commands, or inputs from connected devices like Bluetooth peripherals. The User Interaction Layer facilitates this process by providing various interfaces to capture and relay user inputs to the resource manager, which then influences resource allocation decisions.

At block 240C, the UE analyzes the received inputs using the local AI model to determine a resource allocation strategy. The student AI model processes the inputs to assess the computational demands of the requested applications. For example, the model might prioritize GPU resources for a graphics-intensive application or adjust CPU allocation for data processing tasks. This analysis is informed by application profiles that define resource requirements and guide the resource manager in making allocation decisions.

At block 250C, the UE allocates computational resources between CPUs and GPUs based on the resource allocation strategy. This involves dynamically distributing processing power to optimize application performance. The virtualization layer with orchestration manages this allocation, ensuring that resources are efficiently distributed across virtual machines or containers. For example, additional GPU resources might be allocated to enhance the rendering of a virtual reality application, while CPU resources are adjusted for data-intensive tasks.

At block 260C, the UE executes the application requests using the allocated computational resources. This includes running the applications within a virtualized environment to ensure efficient and secure operation. The application and service layer hosts these virtualized functionalities, continuously monitoring and adjusting application performance to maintain optimal operation. For example, a video editing application might be executed in a virtual machine, leveraging the allocated resources to accelerate processing and rendering tasks.

Additionally, the method may involve monitoring performance metrics and adjusting resource allocation strategies based on real-time data. The feedback loop collects these metrics, providing insights that inform updates to the teacher model on the server. The UE may also receive real-time network loading and battery status information to dynamically adjust resource allocation, ensuring efficient operation and extended battery life. The execution of applications within isolated virtual environments ensures secure and efficient operation, preventing interference between different applications and maintaining system stability.

FIG. 2D is a flowchart illustrating a method that may be performed by the server responsible for maintaining the teacher model, potentially involving components from previous figures such as the model distillation process and feedback loop.

At block 210D, the server receives operational data from a plurality of UEs, including requests and performance metrics. In some embodiments, this involves collecting data that reflects the usage patterns and resource demands of various applications running on the UEs. For example, the server might gather metrics such as CPU and GPU usage, application response times, battery consumption rates, and network latency. This data provides a comprehensive view of how effectively the current resource allocation strategies are meeting the demands of applications, serving as valuable input for refining the teacher model.

At block 220D, the server trains an AI model using the operational data received from the plurality of UEs. In some embodiments, this training process refines the teacher model to encompass a broad range of scenarios and applications. For example, the server might use machine learning techniques to enhance the model's ability to predict resource allocation strategies that optimize performance across different devices. The training process ensures that the teacher model remains responsive to evolving user needs and environmental conditions, supporting the dynamic allocation of resources in UEs.

At block 230D, the server distills the AI model to generate a compressed AI model tailored to a particular UE's hardware configuration. In some embodiments, this distillation process involves extracting essential knowledge from the teacher model and compressing it into a student model that retains high performance while being lightweight enough for efficient operation on the UE. For example, the server might adjust the model to align with the specific processing power and memory constraints of the UE, ensuring that the student model is optimized for execution on the device.

At block 240D, the server sends the compressed AI model to the particular UE. In some embodiments, this transmission is facilitated by network protocols that ensure data integrity and security. For example, the server might schedule updates during low-usage periods to minimize disruption or use differential updates to reduce the amount of data transmitted. This deployment process ensures that UEs receive AI models tailored to their specific capabilities, enabling efficient execution of application requests and optimizing device performance.

At block 250D, the server receives feedback data from the particular UE corresponding to executed application requests. In some embodiments, this feedback includes performance metrics that provide insights into how well the student model is meeting the needs of the applications running on the UE. For example, the server might analyze this data to identify patterns and trends that inform adjustments to the teacher model. The feedback loop facilitates continuous improvement of the AI models, ensuring they remain accurate and efficient.

At block 260D, the server updates the AI model based on the received feedback. In some embodiments, this iterative process allows the teacher model to evolve and adapt to changing user needs and technological advancements. For example, the server might refine the model to improve its accuracy and efficiency in predicting resource allocation strategies. This ongoing refinement ensures that the AI models remain aligned with the latest technological developments and user requirements.

At block 270D, the server sends an updated compressed AI model to the particular UE. In some embodiments, this ensures that the AI models on the devices remain up-to-date and capable of handling evolving application demands and user needs. For example, the server might employ strategies to manage the deployment process, such as scheduling updates during low-usage periods or using differential updates to reduce data transmission. This approach enhances device performance and user experience, enabling seamless execution of complex applications and services.

While for purposes of simplicity of explanation, the respective processes are shown and described as a series of blocks in FIGS. 2C and 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

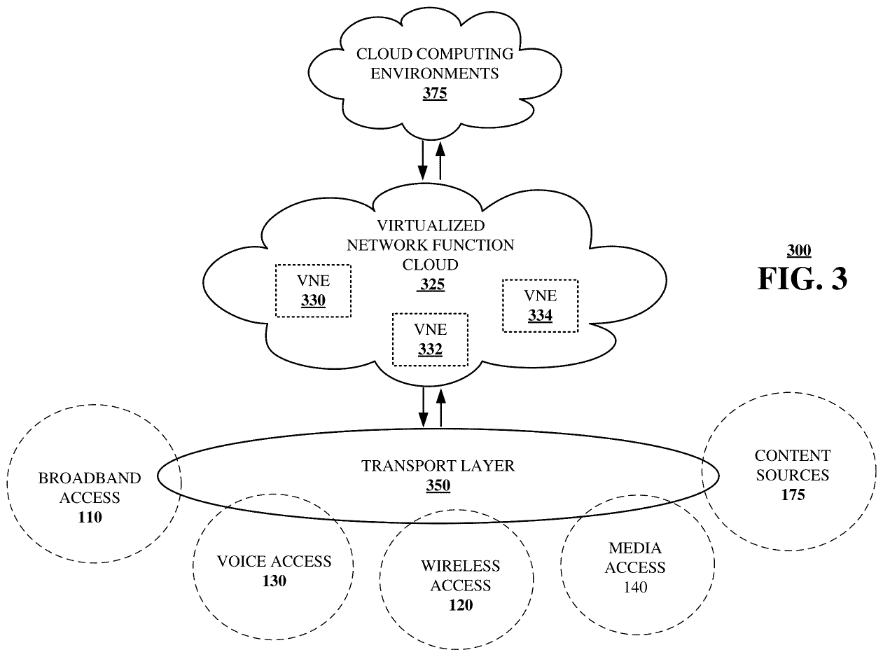

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part utilizing a distilled artificial intelligence (AI) model to dynamically allocate computational resources in user equipment (UE).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

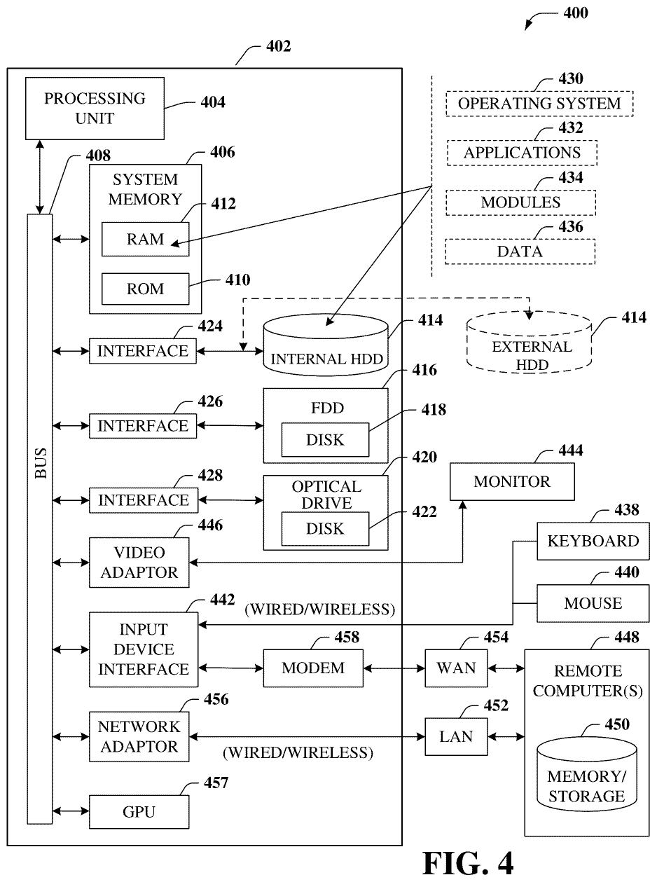

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part utilizing a distilled artificial intelligence (AI) model to dynamically allocate computational resources in user equipment (UE).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In FIG. 4, GPU 457 is a component within the computing environment that provides specialized processing capabilities, complementing the central processing unit (CPU). In some embodiments, GPU 457 may be used to execute parallel processing tasks, particularly those involving complex computations and graphics rendering. For example, the GPU can efficiently handle tasks such as image processing, machine learning inference, and real-time data analytics, which benefit from its ability to perform multiple operations simultaneously.

The role of GPU 457 in resource allocation is significant, as it allows for the dynamic distribution of computational tasks between the CPU and GPU based on the specific demands of applications running on the device. In some embodiments, the GPU may be leveraged to execute AI-driven functionalities, such as running a student AI model that has been distilled from a teacher model. This enables the device to analyze application requests and determine resource allocation strategies, utilizing both the CPU and GPU effectively to meet performance requirements.

Furthermore, GPU 457 contributes to enhancing the overall efficiency and responsiveness of the system. By offloading suitable tasks from the CPU to the GPU, the device can achieve better load balancing and reduce processing bottlenecks. For example, graphics-intensive applications, such as gaming or augmented reality, can benefit from increased GPU resources to render high-quality visuals and maintain smooth operation. Similarly, applications that require intensive data processing, such as real-time analytics, can utilize the GPU's parallel processing capabilities to accelerate computations and improve performance.

In the context of resource allocation, GPU 457 works in conjunction with other components, such as the resource manager and virtualization layer, to dynamically adjust the distribution of compute resources. This collaborative approach allows the device to adapt to changing application demands and user needs, providing a seamless and efficient user experience. By effectively managing the allocation of tasks between the CPU and GPU, the system can optimize power consumption, extend battery life, and support a wide range of applications and workloads.

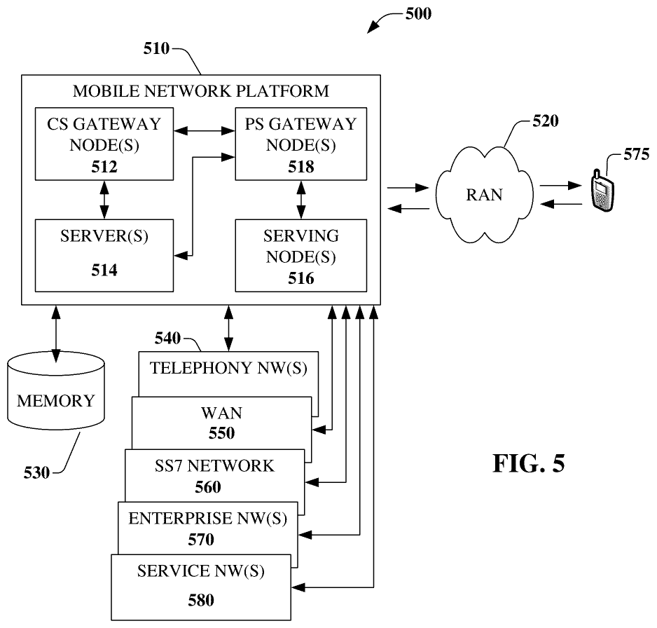

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part utilizing a distilled artificial intelligence (AI) model to dynamically allocate computational resources in user equipment (UE). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

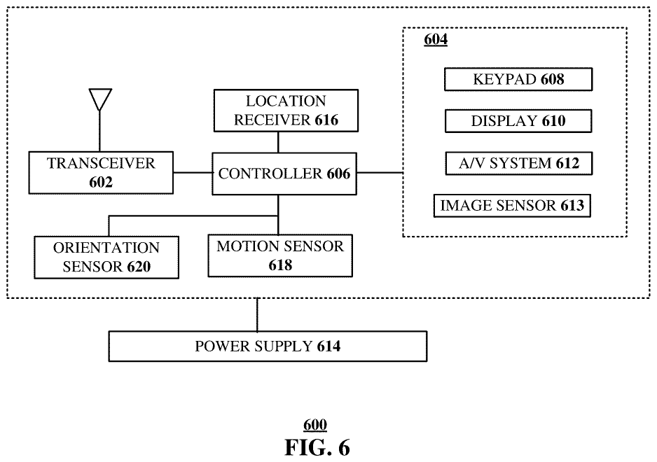

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part utilizing a distilled artificial intelligence (AI) model to dynamically allocate computational resources in user equipment (UE).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, by the device, a student artificial intelligence (AI) model from a server, wherein the student model is derived from a teacher AI model maintained by the server;
executing the student AI model using a graphics processing unit (GPU) of the device;
receiving, by the device, one or more inputs corresponding to application requests via a user interface;
analyzing, by the device, the one or more inputs using the student AI model to determine a resource allocation strategy;
allocating, by the device, computational resources between a central processing unit (CPU) and the GPU based on the resource allocation strategy to create allocated computational resources; and
executing, by the device, the application requests using the allocated computational resources.

2. The device of claim 1, further comprising a performance monitoring module configured to monitor execution metrics associated with the application requests and to refine the resource allocation strategy based on the execution metrics.

3. The device of claim 1, further comprising a battery status sensor operable to obtain battery level information, whereby the resource allocation strategy is adjusted based on the battery level information.

4. The device of claim 1, further comprising a network interface configured to receive real-time network loading information, wherein the resource allocation strategy is dynamically adjusted based on the real-time network loading information.

5. The device of claim 1, wherein the one or more inputs corresponding to application requests include user interface interactions, voice commands, and touch inputs.

6. The device of claim 1, wherein the graphics processing unit (GPU) is configured to concurrently execute the student AI model and perform parallel processing tasks for AI-driven functionalities.

7. The device of claim 1, wherein allocating the computational resources between the central processing unit (CPU) and the GPU comprises dynamically reassigning additional computational resources in response to real-time assessments of application performance demands.

8. The device of claim 1, wherein executing the application requests further comprises executing the application requests within an isolated virtual machine environment instantiated on the device.

9. The device of claim 1, further comprising an interface configured to transmit performance metrics related to the application requests to the server, wherein the performance metrics are used to update the teacher AI model for subsequent derivation of the student AI model.

10. A non-transitory machine-readable medium, comprising executable instructions that, when executed by a processing system including a processor, facilitate performance of operations, the operations comprising:
receiving from a server device, by a user equipment (UE), a first artificial intelligence (AI) model derived from a second AI model, wherein the second AI model is trained on data from a plurality of UEs;
executing the first AI model using a graphics processing unit (GPU) within the UE;
receiving, by the UE, one or more inputs corresponding to application requests via a user interface of the UE;
analyzing, by the UE, the one or more inputs using the first AI model to determine a resource allocation strategy;
allocating, by the UE, computational resources between the processor and the GPU of the UE based on the resource allocation strategy to produce allocated computational resources; and
executing the application requests using the allocated computational resources.

11. The non-transitory machine-readable medium of claim 10, wherein the operations further comprise monitoring, by the UE, a plurality of performance metrics corresponding to the application requests to determine monitored performance metrics, and adjusting the resource allocation strategy based on the monitored performance metrics.

12. The non-transitory machine-readable medium of claim 11, wherein the operations further comprise transmitting, by the UE, the monitored performance metrics to the server device to facilitate updating the second AI model for subsequent derivation of the first AI model.

13. The non-transitory machine-readable medium of claim 10, wherein the operations further comprise receiving, by the UE, real-time network loading information and battery status information, and dynamically adjusting the resource allocation strategy based on the real-time network loading information and battery status information.

14. A method, comprising:
receiving from a server device, by a user equipment (UE) including a processor, a first artificial intelligence (AI) model derived from a second AI model, wherein the second AI model is trained on data from a plurality of UEs;
storing, by the UE, the first AI model to create a local AI model;
receiving, by the UE, one or more inputs corresponding to application requests via a user interface of the UE;
analyzing, by the UE, the one or more inputs using the local AI model to determine a resource allocation strategy;
allocating, by the UE, computational resources between the processor and a graphics processing unit (GPU) of the UE based on the resource allocation strategy to produce allocated computational resources; and
executing the application requests using the allocated computational resources.

15. The method according to claim 14, further comprising: monitoring, by the UE, a plurality of performance metrics corresponding to the application requests to determine monitored performance metrics; and transmitting, by the UE, the monitored performance metrics to the server device to facilitate updating the second AI model.

16. The method according to claim 14, wherein storing the first AI model further comprises distilling the second AI model to create a compressed local AI model tailored to a hardware configuration of the UE.

17. The method according to claim 14, further comprising: receiving, by the UE, real-time network loading information and battery status information; and adjusting the resource allocation strategy based on the real-time network loading information and battery status information.

18. The method according to claim 14, wherein the analyzing the one or more inputs comprises prioritizing the application requests based on a predetermined application profile stored in the UE.

19. The method according to claim 14, wherein allocating the computational resources comprises dynamically reassigning additional computational resources between the processor and the GPU in response to real-time assessments of application performance demands.

20. The method according to claim 14, further comprising executing, by the UE, the application requests within a virtual machine environment instantiated by the UE, the virtual machine environment isolating the application requests from other applications.
